(19) United States
(12) Patent Application Publication
(10) Pub. No.: US 2025/0024437 A1
(43) Pub. Date: Jan. 16, 2025

(54) SENSING SLOTS FOR CELLULAR-BASED RADIO FREQUENCY SENSING

(71) Applicant: QUALCOMM Incorporated, San Diego, CA (US)

(72) Inventors: Weimin DUAN, San Diego, CA (US); Hung Dinh LY, San Diego, CA (US); Alexandros MANOLAKOS, Athens (GR)

(21) Appl. No.: 18/715,984

(22) PCT Filed: Sep. 29, 2022
(86) PCT No.: PCT/US2022/077246

§ 371 Date: Jun. 3, 2024

(30) Foreign Application Priority Data
Dec. 10, 2021 (GR) 20210100867

(51) Int. Cl. H04W 72/0446; G01S 7/00; G01S 13/86; H04L 5/00; H04W 52/02

(52) U.S. Cl. CPC H04W 72/0446; G01S 7/006; G01S 13/86; H04L 5/001; H04W 52/0225

(57) ABSTRACT

Disclosed are techniques for wireless communication and positioning. In an aspect, a base station (BS) may determine a slot configuration that defines at least a portion of one or more slots configured for RF sensing. The BS may send the slot configuration to at least one other telecommunications device, e.g., to another BS if the RF sensing is bistatic radar. The BS may then perform RF sensing according to the slot configuration. In another aspect, a user equipment (UE) may receive a slot configuration that defines at least a portion of one or more slots configured for RF sensing. The UE may operate according to the slot configuration, e.g., the UE may go to low power or sleep mode while the base station is performing RF sensing, and may optionally wake up to receive downlink signals or to transmit uplink signals.

### CROSS-REFERENCE TO RELATED APPLICATIONS

The present application for patent claims the benefit of GR Application No. 20210100867, entitled “SENSING SLOTS FOR CELLULAR-BASED RADIO FREQUENCY SENSING”, filed Dec. 10, 2021, and is a national stage application, filed under 35 U.S.C. § 371, of International Patent Application No. PCT/US2022/077246, entitled, “SENSING SLOTS FOR CELLULAR-BASED RADIO FREQUENCY SENSING”, filed Sep. 29, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (IG), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of radio frequency (RF) sensing performed by a base station (BS) includes determining a slot configuration that defines at least a portion of one or more slots as being configured for RF sensing; and sending the slot configuration to at least one other telecommunications device.

In an aspect, a method performed by a user equipment (UE) includes receiving a slot configuration that defines at least a portion of one or more slots that is configured for RF sensing; and operating according to the slot configuration.

In an aspect, a BS includes a memory, at least one transceiver, and at least one processor communicatively coupled to the memory and the at least one transceiver, the at least one processor configured to determine a slot configuration that defines at least a portion of one or more slots as being configured for RF sensing, and send, via the at least one transceiver, the slot configuration to at least one other telecommunications device.

In an aspect, a UE includes a memory, at least one transceiver, and at least one processor communicatively coupled to the memory and the at least one transceiver, the at least one processor configured to: receive, via the at least one transceiver, a slot configuration that defines at least a portion of one or more slots that is configured for RF sensing, and operate according to the slot configuration.

In an aspect, a BS includes means for determining a slot configuration that defines at least a portion of one or more slots as being configured for RF sensing, and means for sending the slot configuration to at least one other telecommunications device.

In an aspect, a UE includes means for receiving a slot configuration that defines at least a portion of one or more slots that is configured for RF sensing, and means for operating according to the slot configuration.

In an aspect, a non-transitory computer-readable medium storing computer-executable instructions that, when executed by a BS, cause the BS to: determine a slot configuration that defines at least a portion of one or more slots as being configured for RF sensing, and send the slot configuration to at least one other telecommunications device.

In an aspect, a non-transitory computer-readable medium storing computer-executable instructions that, when executed by a UE, cause the UE to: receive a slot configuration that defines at least a portion of one or more slots that is configured for RF sensing, and operate according to the slot configuration.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A. 3B, and 3C are simplified block diagrams of several sample aspects of components that may be employed in a user equipment (UE), a base station (BS), and a network entity, respectively, and configured to support communications as taught herein.

FIG. 4A illustrates the general process of transmitting and collecting millimeter wave (mmW) radio frequency (RF) signal data, according to aspects of the disclosure.

FIG. 4B is a graph illustrating an example waveform of a transmitted and received frequency modulated continuous wave (FMCW) RF signals, according to aspects of the disclosure.

FIG. 4C, FIG. 4D, and FIG. 4E illustrate RF sensing as it may be performed by a gNB or other type of base station, according to aspects of the disclosure.

FIG. 5 is a diagram illustrating an example of a radio frame structure, according to aspects of the disclosure.

FIG. 6 is a diagram of an example scenario in which a UE of a user is within communication range of an access point (AP) or other type of base station, according to aspects of the disclosure.

FIG. 7 illustrates an example of sensing slots for cellular-based RF sensing, according to aspects of the disclosure.

FIG. 8 illustrates an example of sensing mini-slots for cellular-based RF sensing, according to aspects of the disclosure.

FIG. 9A through FIG. 9D are flowcharts of portions of an example process, performed by a base station, associated with sensing slots for cellular-based radio frequency sensing, according to aspects of the disclosure.

FIG. 10A through FIG. 10E are flowcharts of portions of an example process, performed by a UE, associated with sensing slots for cellular-based radio frequency sensing, according to aspects of the disclosure.

FIG. 11 is a signal and event diagram showing an interaction between a UE and a BS associated with sensing slots for cellular-based RF sensing, according to aspects of the disclosure.

### DETAILED DESCRIPTION

Disclosed are techniques for wireless communication and positioning. In an aspect, a base station (BS) may determine a slot configuration that defines at least a portion of one or more slots configured or allocated for RF sensing. The BS may send the slot configuration to at least one other telecommunications device (e.g., to another base station if the RF sensing is bistatic radar). The BS may then perform RF sensing according to the slot configuration. In another aspect, a user equipment (UE) may receive a slot configuration that defines at least a portion of one or more slots configured or allocated for RF sensing. The UE may operate according to the slot configuration (e.g., the UE may go to low power or sleep mode while the base station is performing RF sensing, and may optionally wake up to receive system synchronization blocks (SSBs) or other periodic downlink signals.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device.” a “subscriber terminal,” a “subscriber station,” a “user terminal” or “UT,” a “mobile device,” a “mobile terminal,” a “mobile station.” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

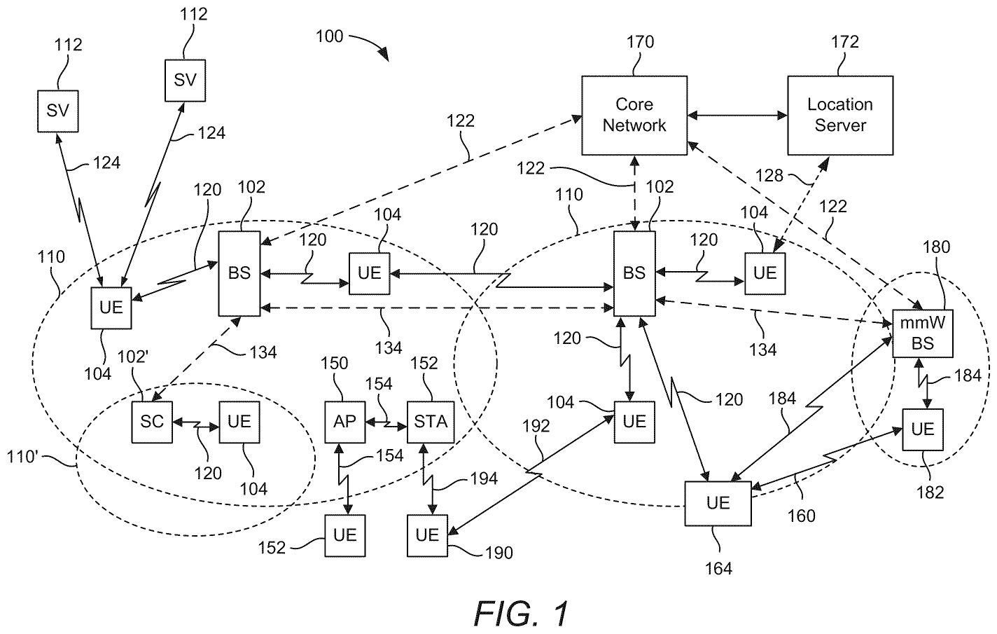

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen-before-talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mm W base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic n is often subdivided, based on frequency/wavelength, into various classes, bands, channels, etc. In 5G NR two initial operating bands have been identified as frequency range designations FRI (410 MHz-7.125 GHz) and FR2 (24.25 GHz-52.6 GHz). It should be understood that although a portion of FR1 is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FRS, or may be within the EHF band.

In a multi-carrier system, such as 5G, one of the carrier frequencies is referred to as the “primary carrier” or “anchor carrier” or “primary serving cell” or “PCell.” and the remaining carrier frequencies are referred to as “secondary carriers” or “secondary serving cells” or “SCells.” In carrier aggregation, the anchor carrier is the carrier operating on the primary frequency (e.g., FRI) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency.” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (cV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1: M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases. UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect. SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

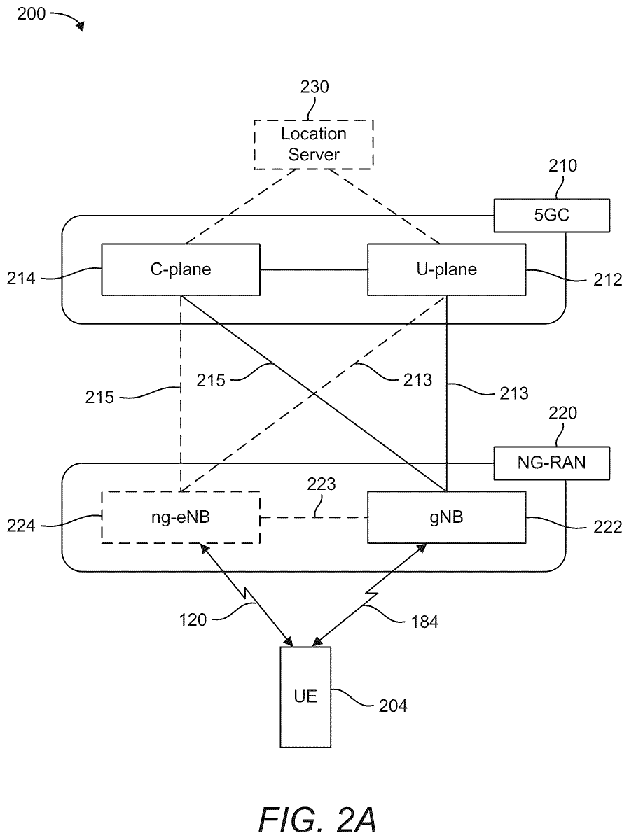

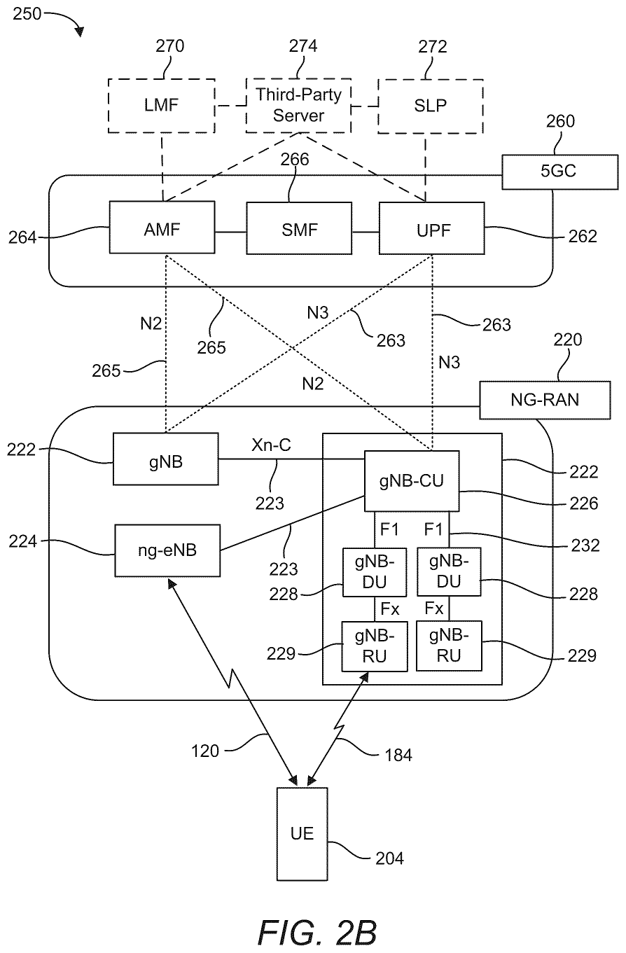

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks. IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

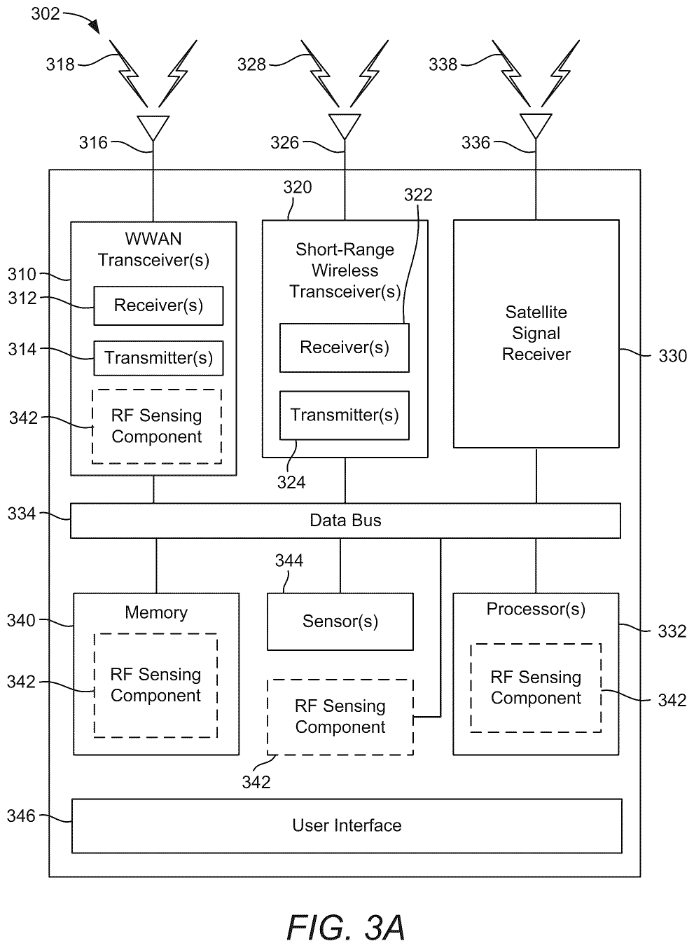

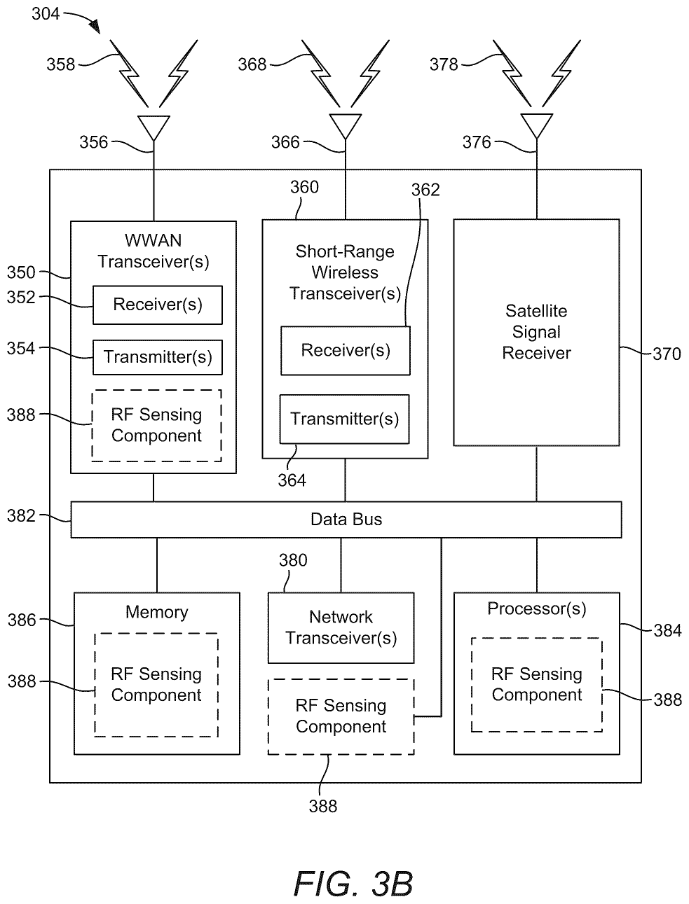

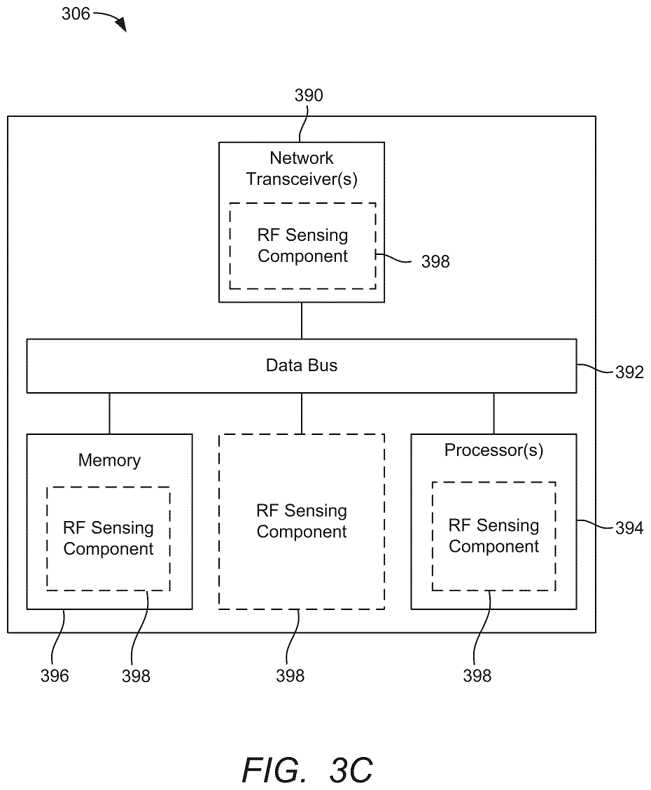

FIG. 3A, FIG. 3B, and FIG. 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave R, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals. Beidou signals, Indian Regional Navigation Satellite System (NAVIC). Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming.” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include RF sensing component 342, 388, and 398, respectively. The RF sensing component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the RF sensing component 342, 388, and 398 may be external to the processors 332, 384, and 394 (e.g., part of a modem processing system, integrated with another processing system, etc.). Alternatively, the RF sensing component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the RF sensing component 342, which may be, for example, part of the one or more WWAN transceivers 310, the memory 340, the one or more processors 332, or any combination thereof, or may be a standalone component. FIG. 3B illustrates possible locations of the RF sensing component 388, which may be, for example, part of the one or more WWAN transceivers 350, the memory 386, the one or more processors 384, or any combination thereof, or may be a standalone component. FIG. 3C illustrates possible locations of the RF sensing component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink. IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting: PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK). M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the RF sensing component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

SG uses RF signals at mmW frequencies for wireless communication between network nodes, such as base stations, UEs, vehicles, factory automation machinery, and the like. However, mmW RF signals can be used for other purposes as well. For example, mmW RF signals can be used in vehicle sensing by mmWave Radar and also mmWave communication through 5G NR (e.g., UE sensing), handheld short range sensing by UEs like smart phone, smart watch, or in-car-based control (e.g., UE sensing), building analytics (e.g., residential security or building management, e.g., gNB sensing), digital health (e.g., device-free eldercare by motion sensing, e.g., higher sensing granularity can be supported by e.g. Terahertz radio, e.g., CPE/AP sensing), sensing for communication (e.g., network management related to beam adaptation, protocol adaptation etc., depending on environments condition obtained through sensing, e.g., gNB/AP sensing), and the like.

RF signals at mmW frequencies can provide high bandwidth and a large aperture to extract accurate range, Doppler, and angle information for environment sensing. Using mmW RF signals for environment sensing can provide such features in a compact form factor, such as a small sensing component that can conveniently fit into a handheld device. Such a sensing component (e.g., a chip) may be a digital signal processor (DSP), a system-on-chip (SoC), or other processing component that can be integrated into another device (a host device), such as a UE, a base station, an IoT device, a factory automation machine, or the like. In an aspect, a sensing component may be, or may be incorporated into, a modem for wireless communication, such as a 5G modem, a 60 GHz WLAN modem, or the like. A device containing a sensing component may be referred to as a host device, an environment sensing device, a sensing device, and the like.

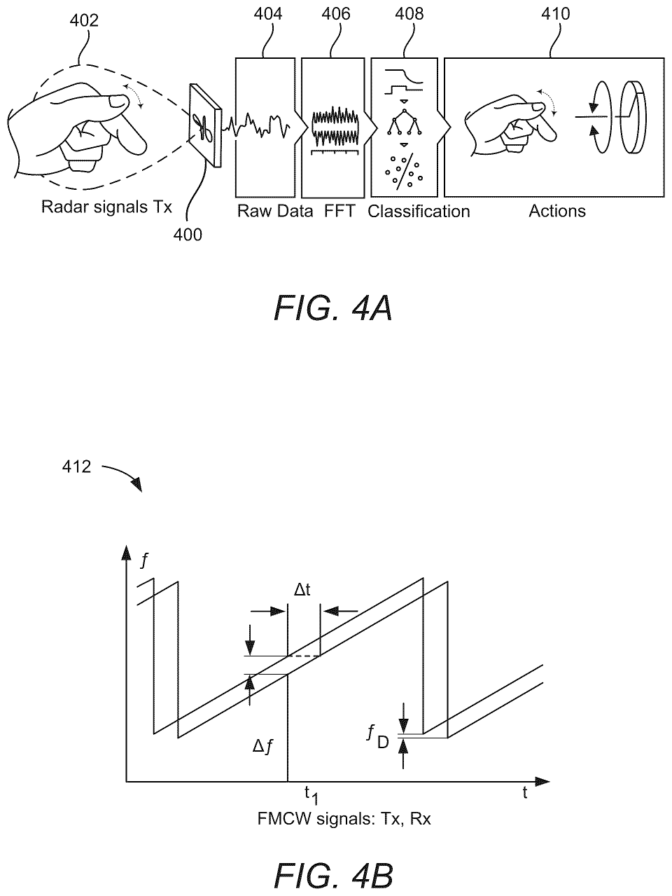

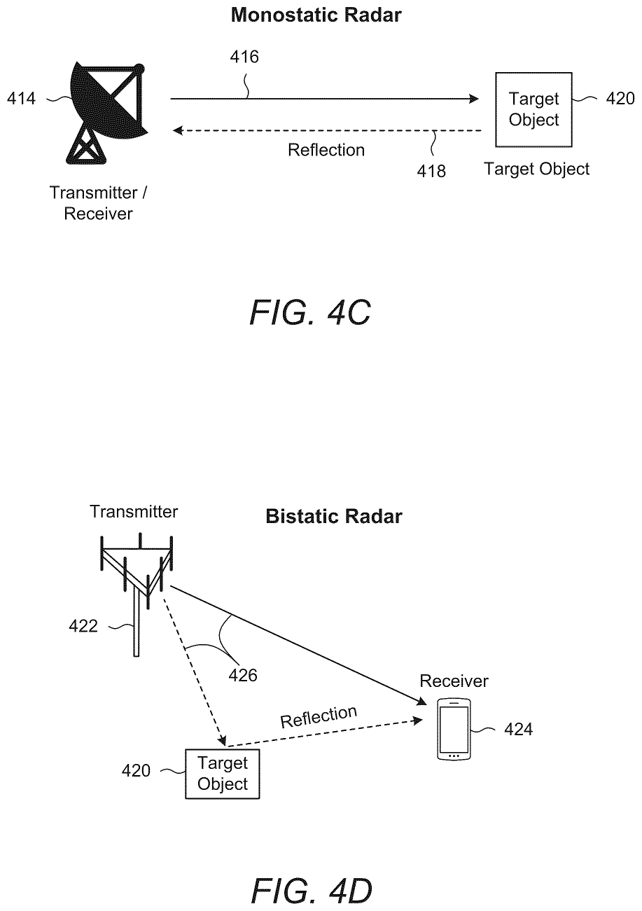

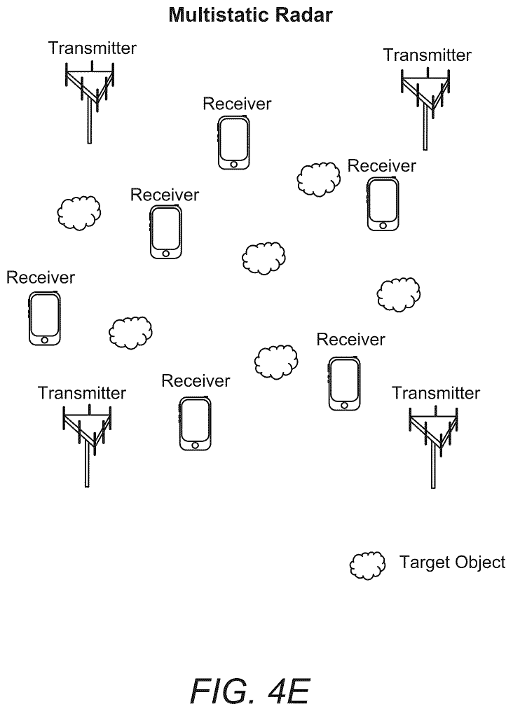

FIG. 4A illustrates the general process of transmitting and collecting mmW RF signal data by a UE using a sensing component 400, according to aspects of the disclosure. In the example of FIG. 4A, at state 402, the sensing component 400 (which may correspond to sensor(s) 344 in FIG. 3A) transmits mmW RF signals with a predefined waveform, such as a frequency modulated continuous wave (FMCW). In FMCW techniques, an RF signal with a known stable frequency continuous wave (i.e., an RF signal with constant amplitude and frequency) varies up and down in frequency over a fixed period of time according to a modulating signal. The mmW RF signals may be transmitted in a beam (e.g., using beamforming) and may reflect off of nearby objects, such as a human face or hand, within the beam. A portion of the transmitted RF signals is reflected back towards the sensing component 400. At stage 404, the sensing component 400 receives/detects the RF return data (i.e., the reflections of the transmitted mmW RF signals).

At stage 406, the sensing component 400 performs a fast Fourier transform (FFT) on the raw RF return data. An FFT converts an RF signal from its original domain (here, time) to a representation in the frequency domain, and vice versa. Frequency differences between the received RF signal and the transmitted RF signal increase with delay (i.e., the time between transmission and reception), and hence, with distance (range). The sensing component 400 correlates reflected RF signals with transmitted RF signals to obtain range, Doppler, and angle information associated with the target object. The range is the distance to the object, the Doppler is the speed of the object, and the angle is the horizontal and/or vertical distance between the detected object and a reference RF ray emitted by the sensing component 400, such as the initial RF ray of a beam sweep.

From the determined properties of the reflected RF signals, the sensing component 400 can determine information about the detected object's characteristics and behaviors, including the size, shape, orientation, material, distance, and velocity of the object. At stage 408, the sensing component 400 classifies the detected object and/or motion of the detected object based on the determined characteristics. For example, the sensing component 400 can use machine learning to classify the detected object as a hand and the motion of the detected object as a twisting motion. At stage 410, based on the classification at stage 408, the sensing component 400 can cause the host device to perform an action, such as turning a virtual dial on the screen of the host device as in the example of FIG. 4.

FIG. 4B is a graph 412 illustrating an example waveform of a transmitted and received FMCW RF signals, according to aspects of the disclosure. FIG. 4B illustrates an example of a sawtooth modulation, which is a common FMCW waveform where range is desired. Range information is mixed with the Doppler velocity using this technique. Modulation can be turned off on alternate scans to identify velocity using unmodulated carrier frequency shift. This allows range and velocity to be determined with one radar set.

As shown in FIG. 4B, the received RF waveform (the lower diagonal lines) is simply a delayed replica of the transmitted RF waveform (the upper diagonal lines). The frequency at which the waveforms are transmitted is used to down-convert the received RF waveform to baseband (a signal that has a near-zero frequency range), and the amount of frequency shift between the transmitted RF waveform and the reflected (received) RF waveform increases with the time delay between them. The time delay is thus a measure of range to the target object. For example, a small frequency spread is produced by reflections from a nearby object, whereas a larger frequency spread is produced by reflections from a further object, thereby resulting in a longer time delay between the transmitted and received RF waveforms.

FIG. 4C, FIG. 4D, and FIG. 4E illustrate RF sensing as it may be performed by a gNB or other type of base station. FIG. 4C illustrates monostatic radar, in which the same entity, e.g., transmitter/receiver 414, transmits the RF sensing signal 416 and receives the reflection(s) 418 from one or more target object(s) 420. FIG. 4D illustrates bistatic radar, in which one entity, e.g., transmitter 422, transmits the RF sensing signal 416, and another entity, e.g., receiver 424, receives the reflection(s) 418 from the target object(s) 420. FIG. 4E illustrates multistatic radar, in which an entity may transmit a signal that is received by multiple other entities, an entity may receive signals that are transmitted by multiple other entities, or both. It is noted that bistatic radar is a type of multistatic radar.

In FIG. 4C, the transmitter and receiver are co-located. This is the typical use case for traditional, or conventional, radar. In FIG. 4D, the transmitter and receiver are not co-located, but rather, are separated. This is the typical use case for wireless communication-based (e.g., WiFi-based, LTE-based, NR-based) RF sensing. Note that while FIG. 4D illustrates using a downlink RF signal as the RF sensing signal, uplink RF signals can also be used as RF sensing signals. In a downlink scenario, as shown, the transmitter 422 is a base station and the receiver 424 is a UE, whereas in an uplink scenario, the transmitter is a UE and the receiver is a base station. It is noted that in a downlink scenario, the receiver 424 may be another base station.

Referring to FIG. 4D in greater detail, the transmitting base station 422 transmits RF sensing signals 426 (e.g., PRS) to the UE 424, but some of the RF sensing signals 426 reflect off a target object 420. In FIG. 4D, the solid line represents RF sensing signals 426 that followed the direct (or line-of-sight (LOS)) path between the base station and the UE, and the dashed lines represent the RF sensing signals 426 that followed a reflected (or non-line-of-sight (NLOS)) path between the base station and the UE due to reflecting off the target object. The base station may have transmitted multiple RF sensing signals 426 in different directions, some of which followed the direct path and others of which followed the reflected path. Alternatively, the base station may have transmitted a single RF sensing signal in a broad enough beam that a portion of the RF sensing signal followed the direct path and a portion of the RF sensing signal followed the reflected path.

The UE can measure the time of arrival (ToAs) of the RF sensing signals received directly from the base station and the ToAs of the RF sensing signals reflected from the target object to determine the distance, and possibly direction, to the target object. More specifically, based on the difference between the ToA of the direct path, the ToA of the reflected path, and the speed of light, the UE can determine the distance to the target object. In addition, if the UE is capable of receive beamforming, the UE may be able to determine the general direction to the target object as the direction of the receive beam on which the RF sensing signal following the reflected path was received. The UE may then optionally report this information to the transmitting base station, an application server associated with the core network, an external client, a third-party application, or some other entity. Alternatively, the UE may report the ToA measurements to the base station, or other entity, and the base station may determine the distance and, optionally, the direction to the target object.

Note that if the RF sensing signals are uplink RF signals transmitted by the UE to the base station, the base station would perform object detection based on the uplink RF signals just as the UE does based on the downlink RF signals.

Referring now to FIG. 4E, the transmitter and receiver are again not co-located. In this scenario, however, there are multiple transmitters (represented graphically in FIG. 4E as base stations, but which may also be UEs) and multiple receivers (represented graphically in FIG. 4E as UEs, but which may also be base stations). This is the typical use case for cellular communication-based (e.g., LTE-based. NR-based) RF sensing. Multistatic radar operates much like the operation of bistatic radar described above with reference to FIG. 4D, except that one transmitter may transmit RF sensing signals to multiple receivers and one receiver may receive RF sensing signals from multiple transmitters.

Possible use cases of multistatic cellular communication-based RF sensing include location detection of device-free objects (i.e., an object that does not itself transmit wireless signals or does not participate in being located). For example, multistatic cellular communication-based RF sensing can be used for environment scanning for self-organization networks (SONs). Currently, in a multistatic radar scenario, all involved base stations either transmit (in which case the involved UEs receive) or receive (in which case the involved UEs transmit).

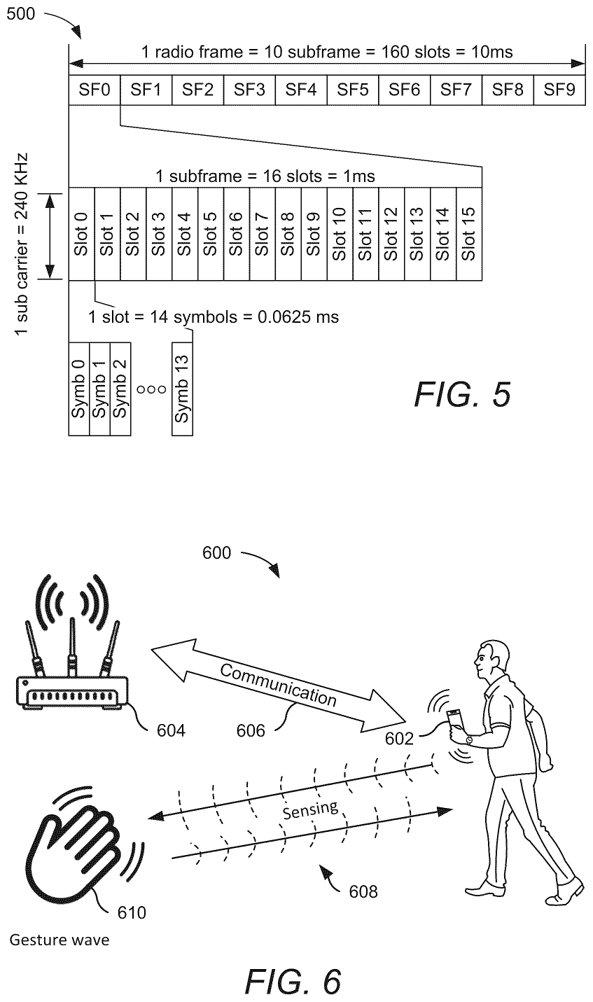

FIG. 5 is a diagram 500 illustrating an example of a radio frame structure, according to aspects of the disclosure. Other wireless communications technologies may have different frame structures and/or different channels.

5G NR utilizes orthogonal frequency division multiplexing (OFDM) on the downlink and single-carrier frequency division multiplexing (SC-FDM) or OFDM on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, SG NR may support multiple numerologies (u), for example, subcarrier spacing (SCS) of 15 kHz, 30 kHz, 60 kHz, 120 kHz, and 240 kHz or greater may be available. Table 1 provided below lists some various parameters for different NR numerologies. As shown in Table 2, the slot length becomes shorter as the SCS becomes wider. For example, for 240 kHz SCS in 28 GHz, there are only 250 microseconds (us) per slot, and the short slot reduces latency.

TABLE 1

| | | | | | | | Max. nominal |
|---|---|---|---|---|---|---|---|
| | | | | | Slot | Symbol | system BW |
| | SCS | Symbols/ | Slots/ | Slots/ | Duration | Duration | (MHz) with 4K |
| μ | (kHz) | Sot | Subframe | Frame | (ms) | (μs) | FFT size |
| 0 | 15 | 14 | 1 | 10 | 1 | 66.7 | 50 |
| 1 | 30 | 14 | 2 | 20 | 0.5 | 33.3 | 100 |
| 2 | 60 | 14 | 4 | 40 | 0.25 | 16.7 | 200 |
| 3 | 120 | 14 | 8 | 80 | 0.125 | 8.33 | 400 |
| 4 | 240 | 14 | 16 | 160 | 0.0625 | 4.17 | 800 |

FIG. 5 illustrates a 5G frame structure for a numerology=4 (i.e., SCS=240 kHz). In FIG. 5, time is represented horizontally (e.g., on the X axis) with time increasing from left to right. In the time domain, a radio frame (e.g., 10 ms) is divided into 10 equally sized subframes of I millisecond (ms) each, and each subframe is divided into 16 time slots of 0.0625 ms each. Each slot is divided into 14 symbols of 4.17 us each. One slot in the time domain and 12 contiguous subcarriers in the frequency domain is referred to as a resource block (RB). RBs are further divided into multiple resource elements (REs). An RE corresponds to one symbol length in the time domain and one subcarrier in the frequency domain.

Beamforming at mmW frequencies would be beneficial in a number of scenarios, including industrial IoT, AR/VR, autonomous driving, gaming, and the like. Each of these scenarios needs large data throughput, accurate beam alignment, fine granularity localization, and ultra-low latency. However, there are various issues that can arise. For example, beam alignment for mobility (i.e., UEs in motion) largely reduces the spectral efficiency and involves additional latency. As another example, for positioning purposes, there is still a gap between current capabilities and the desire to meet the centimeter-level granularity desired for industrial applications. Environmental sensing using 5G mmW RF signals can address these issues.

For environment sensing in 5G mmW frequency bands, a wideband signal using multiple-input multiple-output (MIMO) would be desirable. MIMO is a technique for multiplying the capacity of a radio link using multiple transmission and receiving antennas to exploit multipath propagation. A simple chirp waveform could be used if the only purpose of the transmitted RF signal were for environmental sensing. However, due to the short wavelength, a more complex OFDM waveform in a 5G mmW frequency band can be used for both communication (e.g., over a 5G network) and environment sensing.

FIG. 6 is a diagram 600 of an example scenario in which a UE 602 of a user is within communication range of an AP 604 (or other type of base station), according to aspects of the disclosure. The AP 604 and the UE 602 may communicate over a wireless communication link 606 configured in accordance with, for example, 5G NR or IEEE 802.11ad. In addition, in the downlink, the AP 604 can use environment sensing 608 to detect the user's presence, motion, and actions for, for example, improved communication link establishment (e.g., what direction to form a transmit beam for the communication link). In the uplink, the UE 602 can use environment sensing to provide awareness of interactions with the user (e.g., detection of the hand gesture 610) and/or the AP 604 (e.g., proximity) and/or to determine other personal information.

Due to larger and larger bandwidth allocated for cellular communications systems, such as 5G and beyond, and due to more use cases being introduced within cellular communications systems, joint communication and RF sensing may be a critical feature for future cellular systems. Benefits of using RF signal-based environment sensing include non-vision-based low-power always-on context awareness, meaning the environment sensing device can sense objects and/or actions in any lighting conditions, and even when the object is blocked from view of the environment sensing device. Another benefit is touchless interaction, enabling a user to interact with an environment sensing device without touching a user interface (e.g., touchscreen, keyboard, etc.) of the sensing device. Applications of environment sensing include imaging the environment, such as creating a three-dimensional (3D) map of the environment for VR use cases, high resolution localization for, for example, industrial IoT use cases, assisting communication by, for example, providing more accurate beam tracking, and machine learning for, for example, providing an effective interface between the human user and the machine. One potential problem of sensing, however, is that RF sensing by a first UE may interfere with communication involving a second UE that is not currently communicating with the first UE.

For interference management, simplified air interface design and low complexity hardware implementation, a new type of slot, i.e., a dedicated slot or mini-slot for RF sensing in the cellular networks, is provided. For ease of description, the term “sensing slot” refers herein to a slot that has at least some portion that is reserved for RF sensing. That portion can be the whole slot or just a part of the slot, such as a mini-slot. Slots that are not sensing slots, i.e. slots that have no portion reserved for RF sensing, may be referred to herein as communication slots. The term “sensing slot pattern” refers herein to the pattern of communication slots and sensing slots within a frame.

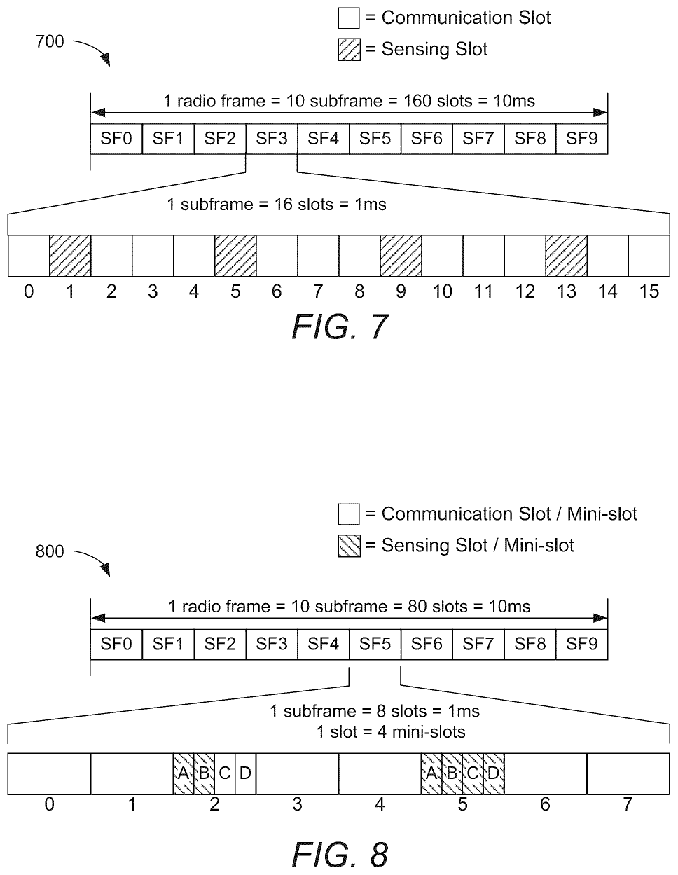

FIG. 7 illustrates an example of sensing slots for cellular-based RF sensing, according to aspects of the disclosure. A radio frame is divided into ten subframes. Depending on the numerology, each subframe may have 1, 2, 4, 8, or 16 slots. For example, for numerology=0, each subframe has just one slot. In FIG. 7, a numerology=4 radio frame 700 comprises 10 subframes labeled SF0 through SF9. Each subframe includes 16 slots, with SF3 shown in detail. FIG. 7 shows an example sensing slot pattern in which the first, fifth, ninth, and thirteenth slots within the third subframe are sensing slots while the other slots in the third subframe are communication slots.

In some aspects, each of the other subframes follows this same pattern of sensing slots used by SF3, i.e., the first, fifth, ninth, and thirteenth slots in the subframe are sensing slots. In other aspects, each of the other subframes may have the same or different patterns of sensing slots compared to each other. For example, in some aspects a number of subframe sensing slot patterns may be defined, and each subframe uses one of the subframe sensing slot patterns.

In other aspects, the subframe construct may be ignored, i.e., by numbering all of the N slots within the radio frame in order (e.g., from 0 to N−1) and identifying which of those N slots within the radio frame are sensing slots.

FIG. 8 illustrates an example of sensing mini-slots for cellular-based RF sensing, according to aspects of the disclosure. In FIG. 8, a numerology=3 radio frame 800 comprises 10 subframes labeled SF0 through SF9. Each subframe includes 8 slots, and each slot is divided into four mini-slots labeled A, B, C, and D. In the example illustrated in FIG. 8, SF5 is shown in detail. FIG. 8 shows an example sensing slot pattern in which slot 2 and slot 5 are sensing slots. In the example illustrated in FIG. 8, mini-slots A and B of slot 2 are sensing mini-slots, mini-slots C and D of slot 2 are communication mini-slots, and mini-slots A, B, C, and D of slot 5 are sensing mini-slots.

In some aspects, each of the other subframes follows this same pattern of sensing mini-slots used by SF5. In other aspects, each of the other subframes may have the same or different patterns of sensing mini-slots compared to each other. For example, in some aspects a number of subframe sensing mini-slot patterns may be defined, and each subframe uses one of the subframe sensing mini-slot patterns.

In other aspects, the subframe construct may be ignored, i.e., by numbering all of the N slots within the radio frame in order (e.g., from 0 to N−1) and identifying which of those N slots within the radio frame are sensing slots.

FIG. 7 and FIG. 8 illustrate the point that the sensing slot pattern of one frame may differ from another frame and the sensing mini-slot pattern of one slot may differ from another slot in the same frame. In some aspects, all of the subframes within a radio frame contain sensing slots, and in other aspects, not all of the subframes within the radio frame contain sensing slots.

The number and location of sensing slots are flexible and can be different from frame to frame and from slot to slot:

Slot location: in some aspects, the sensing slot index within a frame could be fixed or dynamically configured. In some aspects, the slot pattern of the sensing slot over multiple frames could be fixed or dynamically configured. In some aspects, the sensing slot could be periodic or aperiodic, and may depend on the particular use case. Each use case may have different requirements for the slot duration and/or slot period, and so in some aspects, the slot location can be flexibly configured. For example, if the sensing slot is periodic, the period could be indicated by low-latency signaling, such as DCI or MAC-CE.

Slot duration: in some aspects, a sensing slot is the same duration as a regular communication slot, which is a function of the subcarrier spacing (SCS), and may carry a sensing waveform that comprises OFDM symbols. In some aspects, a sensing slot may carry a sensing waveform that does not comprise OFDM symbols, in which case the slot duration may be fixed or dynamically configured rather than a function of the SCS.

Slot configuration: in some aspects, the RF sensing receiver (e.g., the RF transmitting base station in monostatic radar, and a base station other than the RF transmitting base station in bistatic or multistatic radar), is expected to receive the slot pattern information, which may also be provided to UEs that may be within the range of the RF sensing transmissions by the base station, whether or not the UE is the RF sensing receiver. In some aspects, the slot information could be broadcast by a system information block (SIB), e.g., SIB1, or signaled by RRC or DCI. In some aspects, a set of configurations can be signaled or provisioned to the UE or network entity, and the slot configuration to be used may be signaled via RRC or DCI. It is noted that even when the UE is not involved in the RF sensing operation, if the UE is aware of the RF sending slot configuration, the UE may adjust its behavior accordingly, as will be described in more detail below.

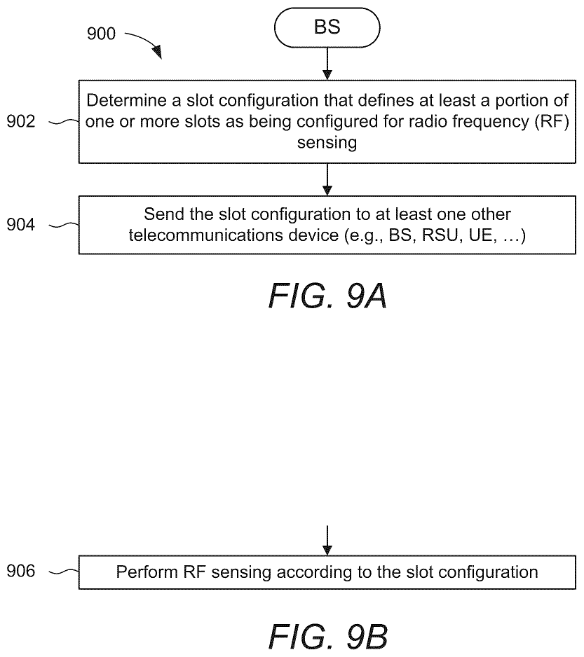

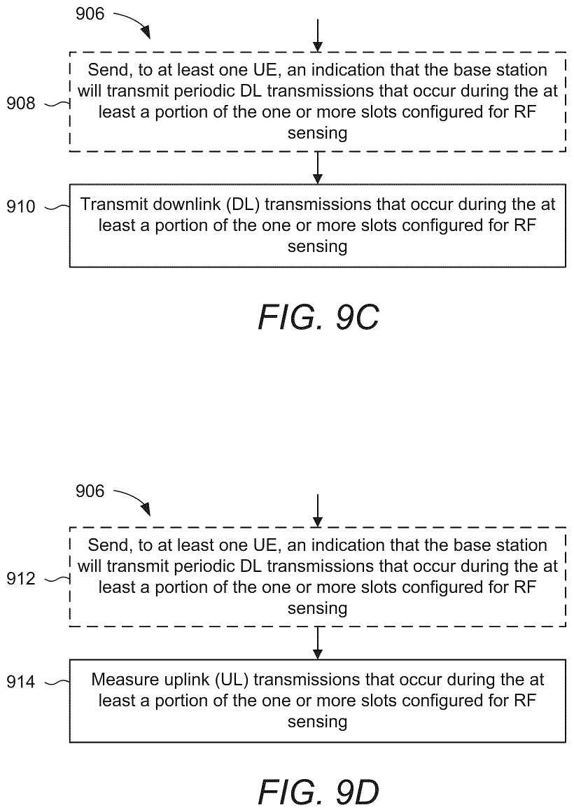

FIG. 9A through FIG. 9D are flowcharts of portions of an example process 900, performed by a base station, associated with sensing slots for cellular-based radio frequency sensing, according to aspects of the disclosure. In some implementations, one or more process blocks of FIGS. 9A-9D may be performed by a base station (BS) (e.g., BS 102). In some implementations, one or more process blocks of FIGS. 9A-9D may be performed by another device or a group of devices separate from or including the BS. Additionally, or alternatively, one or more process blocks of FIGS. 9A-9D may be performed by one or more components of BS 304, such as processor(s) 384, memory 386. WWAN transceiver(s) 350, short-range wireless transceiver(s) 360, satellite signal receiver 370, network transceiver(s) 380, and RF sensing component(s) 388, any or all of which may be means for performing the operations of process 900.

As shown in FIG. 9A, process 900 may include determining a slot configuration that defines at least a portion of one or more slots configured for RF sensing (block 902). Means for performing the operation of block 902 may include the processor(s) 384, memory 386, WWAN transceiver(s) 350, and/or the RF sensing component(s) 388 of the BS 304. For example, the BS 304 may determine a slot configuration that defines at least a portion of one or more slots configured for RF sensing, using the processor(s) 384, the WWAN transceiver(s) 350, and/or the RF sensing component(s) 388.

In some aspects, determining the slot configuration comprises receiving first information that defines the slot configuration, e.g., via the network transceiver(s) 380, or receiving second information that defines a plurality of slot configurations, wherein each of the plurality of slot configurations defines at least a portion of one or more slots configured for RF sensing, and determining one of the plurality of slot configurations as the slot configuration, or a combination thereof. In some aspects, determining one of the plurality of slot configurations as the slot configuration comprises receiving information that is used to select one of the plurality of slot configurations as the slot configuration, e.g., via the network transceiver(s) 380.

As further shown in FIG. 9A, process 900 may include sending the slot configuration to at least one other telecommunications device (block 904). Means for performing the operation of block 904 may include the processor(s) 384, memory 386, or WWAN transceiver(s) 350 of the BS 304. For example, the BS 304 may send the slot configuration to another base station via the network transceiver(s) 380, and/or to a UE via the transmitter(s) 354. In some aspects, sending the slot configuration to the at least one other telecommunications device comprises sending the slot configuration to a user equipment (UE), a road side unit (RSU), or a second base station (BS).

As shown in FIG. 9B, in some aspects, process 900 may further include performing RF sensing according to the slot configuration (block 906). Means for performing the operation of block 906 may include the processor(s) 384, memory 386, or WWAN transceiver(s) 350 of the BS 304. For example, for monostatic radar, the BS 304 may transmit RF sensing signals using the transmitter(s) 354 and receive the reflected signals using the receiver(s) 352.

In some aspects, performing RF sensing according to the slot configuration comprises performing RF sensing on a first component carrier according to a first slot configuration and performing RF sensing on a second component carrier according to a second slot configuration. In some aspects, performing RF sensing according to the slot configuration comprises performing RF sensing on a first component carrier and performing communication on a second component carrier.

In some aspects, performing RF sensing according to the slot configuration comprises performing RF sensing for the at least a portion of one or more slots configured for RF sensing. In some aspects, performing RF sensing according to the slot configuration comprises performing RF sensing for all of at least one of the one or more slots configured for RF sensing. In some aspects, performing RF sensing according to the slot configuration comprises performing RF sensing for a portion less than all of at least one of the one or more slots configured for sensing. In some aspects, the one or more slots are divided into a plurality of mini-slots, and wherein all mini-slots are used for RF sensing, or wherein a subset of mini-slots are used for RF sensing while the remaining mini-slots are used for communication, according to the slot configuration.

In some aspects, performing RF sensing according to the slot configuration comprises performing RF sensing using a first waveform comprising orthogonal frequency division multiplexing (OFDM) symbols, using a second waveform that does not comprise OFDM symbols, or a combination thereof.

In some aspects, performing RF sensing according to the slot configuration comprises performing RF sensing for a duration that is a function of a subcarrier spacing configuration, that is statically configured, or that is dynamically configured.

In some aspects, performing RF sensing according to the slot configuration comprises performing RF sensing according to a period, a repetition count, or a combination thereof.

As shown in FIG. 9C, in some aspects, performing RF sensing according to the slot configuration comprises sending, to at least one UE, an indication that the BS will transmit downlink transmissions that occur during the at least a portion of the one or more slots configured for RF sensing (optional block 908), and transmitting downlink transmissions that occur during the at least a portion of the one or more slots configured for RF sensing (block 910). Means for performing the operation of block 908 and block 910 may include the transceiver(s) 350 of the BS 304. For example, the BS 304 may send the indication to one or more UEs via the transmitter(s) 354, and transmit DL signals also using the transmitter(s) 354. In some aspects, transmitting downlink transmissions that occur during the at least a portion of the one or more slots configured for RF sensing comprises transmitting a synchronous signal block (SSB), a system information block (SIB), a paging signal, a physical downlink control channel (PDCCH), or a physical downlink shared channel (PDSCH).

As shown in FIG. 9D, in some aspects, performing RF sensing according to the slot configuration comprises sending, to at least one UE, an indication that the BS will measure uplink transmissions that occur during the at least a portion of the one or more slots configured for RF sensing (optional block 912), and measuring uplink transmissions that occur during the at least a portion of the one or more slots configured for RF sensing (block 914). Means for performing the operation of block 912 and block 914 may include the transceiver(s) 350 of the BS 304. For example, the BS 304 may send the indication to one or more UEs via the transmitter(s) 354, and measure UL signals using the receiver(s) 352. In some aspects, measuring uplink transmissions that occur during the at least a portion of the one or more slots configured for RF sensing comprises measuring a physical random access channel (PRACH) or a physical uplink shared channel (PUSCH).

Process 900 may include additional implementations, such as any single implementation or any combination of implementations described below and/or in connection with one or more other processes described elsewhere herein. Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

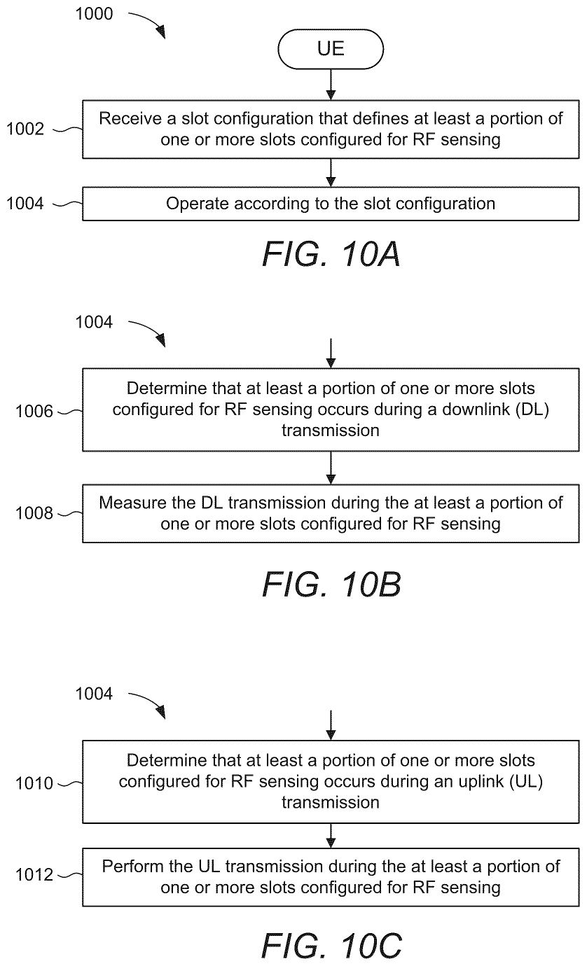

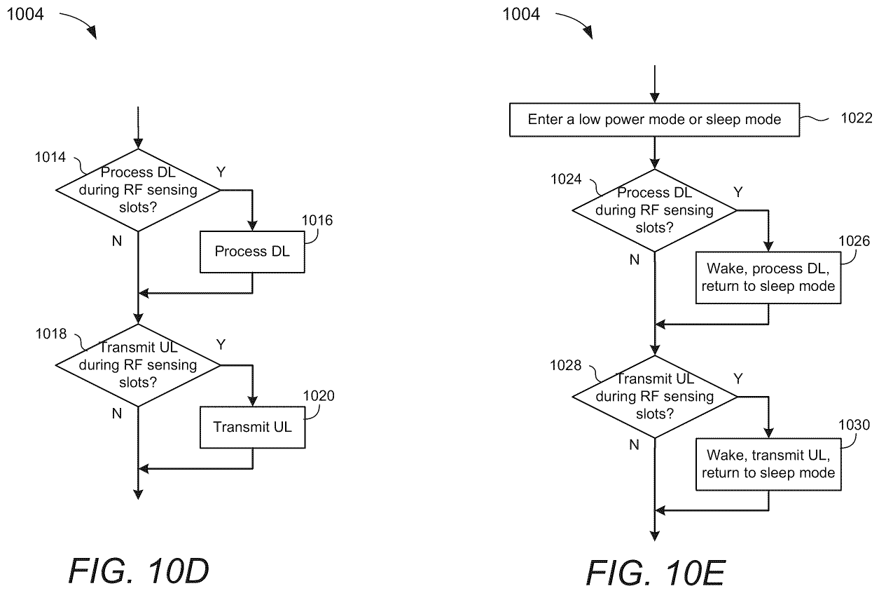

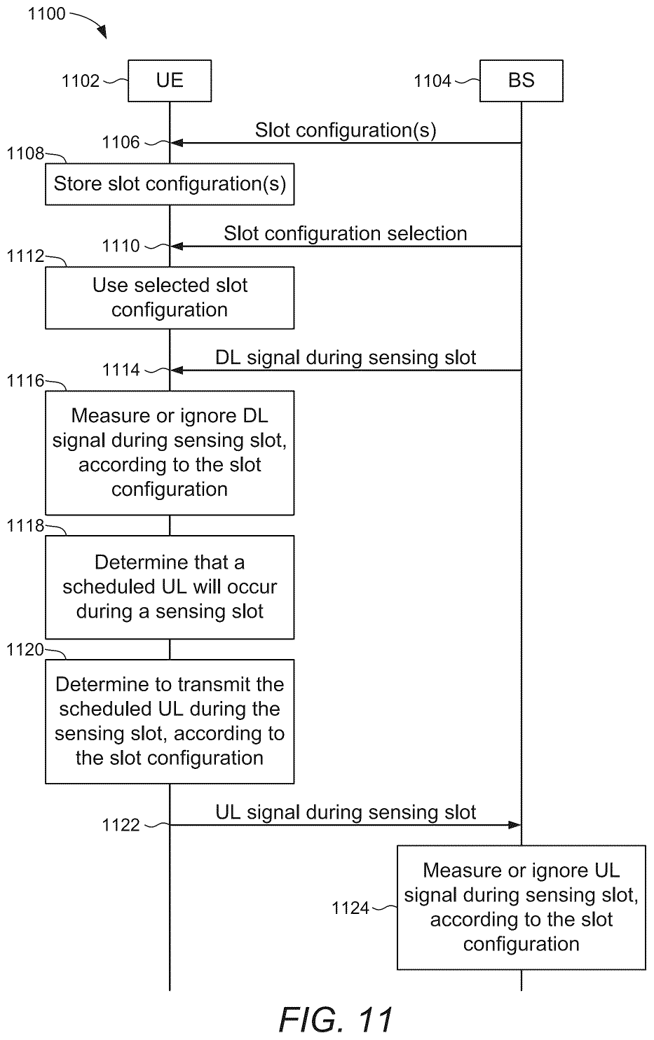

FIG. 10A through FIG. 10E are flowcharts of portions of an example process 1000, performed by a UE, associated with sensing slots for cellular-based radio frequency sensing, according to aspects of the disclosure. In some implementations, one or more process blocks of FIGS. 10A-10E may be performed by a user equipment (UE) (e.g., UE 104). In some implementations, one or more process blocks of FIGS. 10A-10E may be performed by another device or a group of devices separate from or including the UE. Additionally, or alternatively, one or more process blocks of FIGS. 10A-10E may be performed by one or more components of UE 302, such as processor(s) 332, memory 340, WWAN transceiver(s) 310, short-range wireless transceiver(s) 320, satellite signal receiver 330, sensor(s) 344, user interface 346, and RF sensing component(s) 342, any or all of which may be means for performing the operations of process 1000.

As shown in FIG. 10A, process 1000 may include receiving a slot configuration that defines at least a portion of one or more slots configured for RF sensing (block 1002). Means for performing the operation of block 1002 may include the processor(s) 332, memory 340, or WWAN transceiver(s) 310 of the UE 302. For example, the UE 302 may receive a slot configuration from a serving base station, a location server, or some other network node, via the receiver(s) 312.

As further shown in FIG. 10A, process 1000 may include operating according to the slot configuration (block 1004). Means for performing the operation of block 1004 may include the processor(s) 332, memory 340, or WWAN transceiver(s) 310 of the UE 302. For example, the processor(s) 332 of the UE 302 may operate according to the slot configuration stored in the memory 340.

As shown in FIG. 10B, in some aspects, operating according to the slot configuration may comprise determining that at least a portion of one or more slots configured for RF sensing occurs during a DL transmission (block 1006), and measuring the DL transmission during the at least a portion of the one or more slots for RF sensing (block 1008). In some aspects, measuring the DL transmission comprises measuring a synchronous signal block (SSB), a system information block (SIB), a paging signal, a physical downlink control channel (PDCCH), or a physical downlink shared channel (PDSCH). In some aspects, operating according to the slot configuration comprises entering a low power mode or sleep mode during the at least a portion of the one or more slots configured for RF sensing and wherein measuring the DL transmission comprises waking from the low power mode or sleep mode to measure the DL transmission. In some aspects, operating according to the slot configuration comprises determining to wake from the low power mode or sleep mode to measure the DL transmission based on an indication, received by or provisioned to the UE, that a base station will transmit downlink transmissions that occur during the at least a portion of the one or more slots configured for RF sensing.

As shown in FIG. 10C, in some aspects, operating according to the slot configuration may comprise determining that at least a portion of one or more slots configured for RF sensing occurs during an UL transmission (block 1010), and performing the UL transmission during the at least a portion of the one or more slots for RF sensing (block 1012). In some aspects, performing the UL transmission comprises transmitting a physical random access channel (PRACH) or a physical uplink shared channel (PUSCH). In some aspects, operating according to the slot configuration comprises entering a low power mode or sleep mode during the at least a portion of the one or more slots configured for RF sensing and wherein performing the UL transmission comprises waking from the low power mode or sleep mode to perform the UL transmission. In some aspects, operating according to the slot configuration comprises determining to wake from the low power mode or sleep mode to perform the UL transmission based on an indication, received by or provisioned to the UE, that a base station will process uplink transmissions that occur during the at least a portion of the one or more slots configured for RF sensing.

In some aspects, a UE may determine whether or not to enter a low power or sleep mode during RF sensing slots, and when the UE enters a low power or sleep mode, the UE may further determine whether or not to wake up in order to measure an expected DL transmission and/or to transmit a scheduled UL transmission. This is illustrated in FIG. 10D and FIG. 10E.

FIG. 10D illustrates an aspect in which the UE does not enter a low power mode or sleep mode during RF sensing slots. As shown in FIG. 10D, operating according to the slot configuration may comprise determining whether or not to process DL transmissions during RF sensing slots (block 1014), and if so, to process DL transmissions during RF sensing slots (block 1016), and may further comprise determining whether or not to transmit UL transmissions during RF sensing slots (block 1018), and if so, to transmit UL transmissions during RF sensing slots (block 1020).

FIG. 10E illustrates an aspect in which the UE enters a low power mode or sleep mode during RF sensing slots. As shown in FIG. 10E, operating according to the slot configuration may comprise entering a low power mode or sleep mode (block 1022), determining whether or not to process DL transmissions during RF sensing slots (block 1024), and if so, to wake, process DL transmissions during RF sensing slots, and optionally return to sleep mode (block 1026), and may further comprise determining whether or not to transmit UL transmissions during RF sensing slots (block 1028), and if so, to wake, transmit UL transmissions during RF sensing slots, and optionally return to sleep mode (block 1030).

In some aspects, the decision, in block 1024, whether or not to wake to process DL transmissions may be based an indication, received by the UE 302 or provisioned to the UE 302, that a base station will or will not transmit periodic DL transmissions that occur during the at least a portion of the one or more slots configured for RF sensing, or based on other conditions or indicia. Likewise, the decision, in block 1028, whether or not to wake to transmit UL transmissions may be based an indication, received by the UE 302 or provisioned to the UE 302, that a base station will or will not process periodic UL transmissions that occur during the at least a portion of the one or more slots configured for RF sensing, or based on other conditions or indicia.

In one example, the periodic downlink transmission that occurs during the at least a portion of the one or more slots configured for RF sensing comprises a synchronization signal block (SSB). In this example, a base station may signal to UE 302 that the base station will not be transmitting the SSB (or other signal) during the slots configured for RF sensing, in which case the UE 302 may determine that it can go into sleep mode and not have to wake up to process an SSB that is not there

In another example, the base station may signal to the UE 302 that the base station will be transmitting the SSB during the slots configured for RF sensing, in which case the UE 302 may be able to make its own decision whether or not to wake up to monitor the SSB signal.

Alternatively, the UE 302 may be signaled or provisioned to wake up to monitor the SSB signal whenever the base station indicates that the base station will transmit it even during slots configured for RF sensing.

Yet another alternative is that the UE 302 will be configured to presume, without any information provided by the base station, that the base station will always transmit certain DL signals even during slots for RF sensing, in which case the UE 302 will always wake from a sleep mode in order to measure the SSB or other signals, which the UE 302 presumes will be there regardless. These implementation details are illustrative and not limiting.

Process 1000 may include additional implementations, such as any single implementation or any combination of implementations described below and/or in connection with one or more other processes described elsewhere herein. Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a signal and event diagram 1100 showing an interaction between a UE 1102 and a BS 1104 associated with sensing slots for cellular-based RF sensing, according to aspects of the disclosure.

As shown in FIG. 11, a UE 1102 may receive one or more slot configurations that define at least a portion of one or more slots for performing radio frequency (RF) sensing (block 1106). The UE 1102 may store the one or more slot configurations (block 1108), e.g., in memory. In some aspects, this information can be transmitted to the UE via RRC. The UE 1102 may then receive information that indicates a slot configuration selection (block 1110), e.g., from the BS 1104 or other network node. In some aspects, this information may be transmitted to the UE 1102 via DCI or MAC-CE. The UE 1102 may then use the selected slot configuration (block 1112).

A UE that is involved in a sensing operation may transmit, receive, or both during a sensing slot, while a UE that is not involved in the sensing operation is not expected to transmit or receive during a sensing slot. In some aspects, a UE that is not involved in a sensing operation during the sensing slot may enter a sleep mode, such as when the base stations are operating as the sensing transmitters and/or receivers. This could reduce interference during the sensing operation, e.g., sensing entities are not interfered with by communicating entities and communication entities are not interfered with by sensing entities. In some aspects, a UE is not scheduled for UL or DL communication during the sensing slots.

However, some special communications signals, such as periodic DL broadcasts or pre-configured UL transmissions, may collide with the sensing slots. Such signals include, but are not limited to, synchronization signal blocks (SSBs), system information blocks (SIBs), and paging signals. For example, an SSB may be present during the sensing slots. In FIG. 11, for example, the BS 1104 transmits a DL signal 1114 during a sensing slot.

This scenario may be handled by the UE 1102 in a number of ways. In one approach, the UE 1102 presumes that the SSB is not present during the sensing slots, and will skip any measurement related to the SSB during a sensing slot. Under this approach, in some aspects the BS 1104 may optionally skip SSB transmission during a sensing slot, e.g., if the BS 1104 knows that the UE 1102 will not measure SSB during the sensing slot. In this approach, the UE 1102 may be configured to simply ignore SSB during sensing slots, regardless of whether or not the BS 1104 actually transmits SSB during sensing slots.

In another approach, the UE 1102 presumes that the SSB is present during the sensing slots, and will perform SSB measurements, e.g., for RLM, RRM, BM, during the sensing slot. This approach allows the SSB-related procedures to be unchanged. In this approach, the UE 1102 may be configured as usual, which is an implicit configuration to measure SSBs even if they occur within sensing slots, or the UE 1102 may be explicitly configured to measure SSBs even if they occur within sensing slots.

It is noted that the presence of SSB during sensing slots may create a negligible (or acceptable) amount of interference of sensing operations that take place during the sensing slots. Thus, in yet another approach, the BS 1104 does not suppress transmission of SSB during the sensing slots, the UE 1102 measures SSB during the sensing slots, and the UE 1102 may also perform RF sensing during that sensing slot. In this approach, the UE 1102 may be explicitly configured to allow the UE 1102 to perform RF sensing and measure SSB during sensing slots.

System information (SI) and paging signals may be present during the sensing slots, since they are periodically broadcast. In some aspects, the UE 1102 may skip PDCCH monitoring if system information and/or paging PDCCH monitoring occasions happen to be within the sensing slot. If a PDCCH in a PDCCH monitoring occasion with a sensing slot carries a PDSCH grant that occurs in a sensing slot, in some aspects, the UE 1102 may skip PDSCH reception, while in other aspects, the UE 1102 may follow the scheduling to receive the PDSCH (less likely since the sensing slots are not for communication). Likewise, the same considerations may be applied to PRACH occasions, semi-persistent scheduling (SPS) PDSCH occasions, and/or configured grant PUSCH occasions.

In some aspects, the decision whether the UE 1102 should attempt to measure communication signals during the sensing slot may depend upon the UE's capabilities. In the example shown in FIG. 11, the UE determines whether to measure or ignore the DL signal during the sensing slot, according to the slot configuration (block 1116).

It may also be the case that a scheduled UL transmission will occur during a sensing slot. This scenario, too, may be handled by the UE 1102 in a number of ways. In one approach, the UE 1102 transmits the scheduled UL transmission as usual. In another approach, the UE 1102 may does not transmit the scheduled UL transmission during the sensing slot. In yet another approach the UE 1102 may determine whether or not to transmit the scheduled UL transmission during the sensing slot based on one or more factors, such as UE capability or other considerations. In the example in FIG. 11, the UE 1102 determines that a scheduled UL will occur during a sensing slot (block 1118) and determines to transmit the scheduled UL during the sensing slot, according to the slot configuration (block 1120). The UE 1102 then transmits the UL signal during the sensing slot (block 1122).

In the example shown in FIG. 11, the BS 1104 knows that there is a scheduled UL signal during a sensing slot, e.g., since it was the BS 1104 that scheduled it. In the example shown in FIG. 11, the BS 1104 may measure the UL signal from the UE 1102, or it may ignore (not measure, or measure, then discard) the UL signal from the UE 1102, according to the slot configuration (block 1124).

As will be appreciated, a technical advantage of the method X00 is that, by defining a slot or portion of a slot for RF sensing, RF sensing accuracy and efficiency can be improved, due to reduced interference from communication signals, and vice versa.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:
Clause 1. A method of radio frequency (RF) sensing performed by a base station (BS), the method comprising: determining a slot configuration that defines at least a portion of one or more slots as being configured for RF sensing; and sending the slot configuration to at least one other telecommunications device.
Clause 2. The method of clause 1, wherein determining the slot configuration comprises: receiving first information that defines the slot configuration; receiving second information that defines a plurality of slot configurations, wherein each of the plurality of slot configurations defines at least a portion of one or more slots for RF sensing, and determining one of the plurality of slot configurations as the slot configuration; or a combination thereof.
Clause 3. The method of clause 2, wherein determining one of the plurality of slot configurations as the slot configuration comprises receiving information that is used to select one of the plurality of slot configurations as the slot configuration.
Clause 4. The method of any of clauses 1 to 3, wherein sending the slot configuration to at least one other telecommunications device comprises sending the slot configuration to at least one of a user equipment (UE), a network entity, or another base station.
Clause 5. The method of any of clauses 1 to 4, further comprising performing RF sensing according to the slot configuration.
Clause 6. The method of clause 5, wherein performing RF sensing according to the slot configuration comprises performing RF sensing on a first component carrier according to a first slot configuration and performing RF sensing on a second component carrier according to a second slot configuration.
Clause 7. The method of any of clauses 5 to 6, wherein performing RF sensing according to the slot configuration comprises performing RF sensing on a first component carrier and performing communication on a second component carrier.
Clause 8. The method of any of clauses 5 to 7, wherein performing RF sensing according to the slot configuration comprises performing RF sensing for the at least a portion of one or more slots configured for RF sensing.
Clause 9. The method of any of clauses 5 to 8, wherein performing RF sensing according to the slot configuration comprises performing RF sensing for all of at least one of the one or more slots configured for RF sensing.
Clause 10. The method of any of clauses 5 to 9, wherein performing RF sensing according to the slot configuration comprises performing RF sensing for a portion less than all of at least one of the one or more slots configured for sensing.
Clause 11. The method of any of clauses 5 to 10, wherein the one or more slots are divided into a plurality of mini-slots, and wherein all mini-slots are used for RF sensing, or wherein a subset of mini-slots are used for RF sensing while the remaining mini-slots are used for communication, according to the slot configuration.
Clause 12. The method of any of clauses 5 to 11, wherein performing RF sensing according to the slot configuration comprises performing RF sensing using a first waveform comprising orthogonal frequency division multiplexing (OFDM) symbols, using a second waveform that does not comprise OFDM symbols, or a combination thereof.
Clause 13. The method of any of clauses 5 to 12, wherein performing RF sensing according to the slot configuration comprises performing RF sensing for a duration that is a function of a subcarrier spacing configuration, that is statically configured, or that is dynamically configured.
Clause 14. The method of any of clauses 5 to 13, wherein performing RF sensing according to the slot configuration comprises performing RF sensing according to a period, a repetition count, or a combination thereof.
Clause 15. The method of any of clauses 1 to 14, further comprising sending, to at least one UE, an indication that the BS will transmit downlink transmissions that occur during the at least a portion of the one or more slots configured for RF sensing.
Clause 16. The method of any of clauses 1 to 15, further comprising transmitting downlink transmissions that occur during the at least a portion of the one or more slots configured for RF sensing.
Clause 17. The method of clause 16, wherein transmitting downlink transmissions that occur during the at least a portion of the one or more slots configured for RF sensing comprises transmitting a synchronous signal block (SSB), a system information block (SIB), a paging signal, a physical downlink control channel (PDCCH), or a physical downlink shared channel (PDSCH).
Clause 18. The method of any of clauses 1 to 17, further comprising sending, to at least one UE, an indication that the BS will measure uplink transmissions that occur during the at least a portion of the one or more slots configured for RF sensing.
Clause 19. The method of any of clauses 1 to 18, further comprising measuring uplink transmissions that occur during the at least a portion of the one or more slots configured for RF sensing.
Clause 20. The method of clause 19, wherein measuring uplink transmissions that occur during the at least a portion of the one or more slots configured for RF sensing comprises measuring a physical random access channel (PRACH) or a physical uplink shared channel (PUSCH).
Clause 21. A method performed by a user equipment (UE), the method comprising: receiving a slot configuration that defines at least a portion of one or more slots that is configured for RF sensing; and operating according to the slot configuration.
Clause 22. The method of clause 21, wherein operating according to the slot configuration comprises: determining that the at least a portion of the one or more slots for RF sensing occurs during a downlink (DL) transmission; and measuring the DL transmission during the at least a portion of the one or more slots for RF sensing.
Clause 23. The method of clause 22, wherein measuring the DL transmission comprises measuring a system synchronization block (SSB), a system information block (SIB), a paging signal, a physical downlink control channel (PDCCH), or a physical downlink shared channel (PDSCH).
Clause 24. The method of any of clauses 22 to 23, wherein operating according to the slot configuration comprises entering a low power mode or sleep mode during the at least a portion of the one or more slots configured for RF sensing and wherein measuring the DL transmission comprises waking from the low power mode or sleep mode to measure the DL transmission.
Clause 25. The method of clause 24, wherein operating according to the slot configuration comprises determining to wake from the low power mode or sleep mode to measure the DL transmission based on an indication, received by or provisioned to the UE, that a base station will transmit downlink transmissions that occur during the at least a portion of the one or more slots configured for RF sensing.
Clause 26. The method of any of clauses 21 to 25, further comprising: determining that the at least a portion of the one or more slots for RF sensing occurs during an uplink (UL) transmission; and performing the UL transmission during the at least a portion of the one or more slots for RF sensing.
Clause 27. The method of clause 26, wherein performing the UL transmission comprises transmitting a physical random access channel (PRACH) or a physical uplink shared channel (PUSCH).
Clause 28. The method of any of clauses 26 to 27, wherein operating according to the slot configuration comprises entering a low power mode or sleep mode during the at least a portion of the one or more slots configured for RF sensing and wherein performing the UL transmission comprises waking from the low power mode or sleep mode to perform the UL transmission.
Clause 29. The method of clause 28, wherein operating according to the slot configuration comprises determining to wake from the low power mode or sleep mode to perform the UL transmission based on an indication, received by or provisioned to the UE, that a base station will process uplink transmissions that occur during the at least a portion of the one or more slots configured for RF sensing.
Clause 30. A base station (BS), comprising: a memory; at least one transceiver; and at least one processor communicatively coupled to the memory and the at least one transceiver, the at least one processor configured to: determine a slot configuration that defines at least a portion of one or more slots as being configured for RF sensing; and send, via the at least one transceiver, the slot configuration to at least one other telecommunications device.
Clause 31. The BS of clause 30, wherein, to determine the slot configuration, the at least one processor is configured to: receive, via the at least one transceiver, first information that defines the slot configuration; receive, via the at least one transceiver, second information that defines a plurality of slot configurations, wherein each of the plurality of slot configurations defines at least a portion of one or more slots for RF sensing, and determine one of the plurality of slot configurations as the slot configuration; or a combination thereof.
Clause 32. The BS of clause 31, wherein, to determine one of the plurality of slot configurations as the slot configuration, the at least one processor is configured to receive information that is used to select one of the plurality of slot configurations as the slot configuration.
Clause 33. The BS of any of clauses 30 to 32, wherein, to send the slot configuration to at least one other telecommunications device, the at least one processor is configured to send the slot configuration to at least one of a user equipment (UE), a network entity, or another base station.
Clause 34. The BS of any of clauses 30 to 33, wherein the at least one processor is further configured to perform RF sensing according to the slot configuration.
Clause 35. The BS of clause 34, wherein, to perform RF sensing according to the slot configuration, the at least one processor is configured to perform RF sensing on a first component carrier according to a first slot configuration and perform RF sensing on a second component carrier according to a second slot configuration.
Clause 36. The BS of any of clauses 34 to 35, wherein, to perform RF sensing according to the slot configuration, the at least one processor is configured to perform RF sensing on a first component carrier and perform communication on a second component carrier.
Clause 37. The BS of any of clauses 34 to 36, wherein, to perform RF sensing according to the slot configuration, the at least one processor is configured to perform RF sensing for the at least a portion of one or more slots configured for RF sensing.
Clause 38. The BS of any of clauses 34 to 37, wherein, to perform RF sensing according to the slot configuration, the at least one processor is configured to perform RF sensing for all of at least one of the one or more slots configured for RF sensing.
Clause 39. The BS of any of clauses 34 to 38, wherein, to perform RF sensing according to the slot configuration, the at least one processor is configured to perform RF sensing for a portion less than all of at least one of the one or more slots configured for sensing.
Clause 40. The BS of any of clauses 34 to 39, wherein the one or more slots are divided into a plurality of mini-slots, and wherein all mini-slots are used for RF sensing, or wherein a subset of mini-slots are used for RF sensing while the remaining mini-slots are used for communication, according to the slot configuration.
Clause 41. The BS of any of clauses 34 to 40, wherein, to perform RF sensing according to the slot configuration, the at least one processor is configured to perform RF sensing using a first waveform comprising orthogonal frequency division multiplexing (OFDM) symbols, using a second waveform that does not comprise OFDM symbols, or a combination thereof.
Clause 42. The BS of any of clauses 34 to 41, wherein, to perform RF sensing according to the slot configuration, the at least one processor is configured to perform RF sensing for a duration that is a function of a subcarrier spacing configuration, that is statically configured, or that is dynamically configured.
Clause 43. The BS of any of clauses 34 to 42, wherein, to perform RF sensing according to the slot configuration, the at least one processor is configured to perform RF sensing according to a period, a repetition count, or a combination thereof.
Clause 44. The BS of any of clauses 30 to 43, wherein the at least one processor is further configured to send, via the at least one transceiver, to at least one UE, an indication that the BS will transmit downlink transmissions that occur during the at least a portion of the one or more slots configured for RF sensing.
Clause 45. The BS of any of clauses 30 to 44, wherein the at least one processor is further configured to transmit, via the at least one transceiver, downlink transmissions that occur during the at least a portion of the one or more slots configured for RF sensing.
Clause 46. The BS of clause 45, wherein, to transmit downlink transmissions that occur during the at least a portion of the one or more slots configured for RF sensing, the at least one processor is configured to transmit a synchronous signal block (SSB), a system information block (SIB), a paging signal, a physical downlink control channel (PDCCH), or a physical downlink shared channel (PDSCH).
Clause 47. The BS of any of clauses 30 to 46, wherein the at least one processor is further configured to send, via the at least one transceiver, to at least one UE, an indication that the BS will measure uplink transmissions that occur during the at least a portion of the one or more slots configured for RF sensing.
Clause 48. The BS of any of clauses 30 to 47, wherein the at least one processor is further configured to measure uplink transmissions that occur during the at least a portion of the one or more slots configured for RF sensing.
Clause 49. The BS of clause 48, wherein, to measure uplink transmissions that occur during the at least a portion of the one or more slots configured for RF sensing, the at least one processor is configured to measure a physical random access channel (PRACH) or a physical uplink shared channel (PUSCH).
Clause 50. A user equipment (UE), comprising: a memory; at least one transceiver; and at least one processor communicatively coupled to the memory and the at least one transceiver, the at least one processor configured to: receive, via the at least one transceiver, a slot configuration that defines at least a portion of one or more slots that is configured for RF sensing; and operate according to the slot configuration.
Clause 51. The UE of clause 50, wherein, to operate according to the slot configuration, the at least one processor is configured to: determine that the at least a portion of the one or more slots for RF sensing occurs during a downlink (DL) transmission; and measure the DL transmission during the at least a portion of the one or more slots for RF sensing.
Clause 52. The UE of clause 51, wherein, to measure the DL transmission, the at least one processor is configured to measure a system synchronization block (SSB), a system information block (SIB), a paging signal, a physical downlink control channel (PDCCH), or a physical downlink shared channel (PDSCH).
Clause 53. The UE of any of clauses 51 to 52, wherein operating according to the slot configuration comprises entering a low power mode or sleep mode during the at least a portion of the one or more slots configured for RF sensing and wherein, to measure the DL transmission, the at least one processor is configured to wake from the low power mode or sleep mode to measure the DL transmission.
Clause 54. The UE of clause 53, wherein, to operate according to the slot configuration, the at least one processor is configured to determine to wake from the low power mode or sleep mode to measure the DL transmission based on an indication, received by or provisioned to the UE, that a base station will transmit downlink transmissions that occur during the at least a portion of the one or more slots configured for RF sensing.
Clause 55. The UE of any of clauses 50 to 54, wherein the at least one processor is further configured to: determine that the at least a portion of the one or more slots for RF sensing occurs during an uplink (UL) transmission; and perform the UL transmission during the at least a portion of the one or more slots for RF sensing.
Clause 56. The UE of clause 55, wherein, to perform the UL transmission, the at least one processor is configured to transmit a physical random access channel (PRACH) or a physical uplink shared channel (PUSCH).
Clause 57. The UE of any of clauses 55 to 56, wherein operating according to the slot configuration comprises entering a low power mode or sleep mode during the at least a portion of the one or more slots configured for RF sensing and wherein, to perform the UL transmission, the at least one processor is configured to wake from the low power mode or sleep mode to perform the UL transmission.
Clause 58. The UE of clause 57, wherein, to operate according to the slot configuration, the at least one processor is configured to determine to wake from the low power mode or sleep mode to perform the UL transmission based on an indication, received by or provisioned to the UE, that a base station will process uplink transmissions that occur during the at least a portion of the one or more slots configured for RF sensing.
Clause 59. A base station (BS), comprising: means for determining a slot configuration that defines at least a portion of one or more slots as being configured for RF sensing; and means for sending the slot configuration to at least one other telecommunications device.
Clause 60. A user equipment (UE), comprising: means for receiving a slot configuration that defines at least a portion of one or more slots that is configured for RF sensing; and means for operating according to the slot configuration.
Clause 61. A non-transitory computer-readable medium storing computer-executable instructions that, when executed by a base station (BS), cause the BS to: determine a slot configuration that defines at least a portion of one or more slots as being configured for RF sensing; and send the slot configuration to at least one other telecommunications device.
Clause 62. A non-transitory computer-readable medium storing computer-executable instructions that, when executed by a user equipment (UE), cause the UE to: receive a slot configuration that defines at least a portion of one or more slots that is configured for RF sensing; and operate according to the slot configuration.
Clause 63. An apparatus comprising a memory, a transceiver, and a processor communicatively coupled to the memory and the transceiver, the memory, the transceiver, and the processor configured to perform a method according to any of clauses 1 to 29.
Clause 64. An apparatus comprising means for performing a method according to any of clauses 1 to 29.
Clause 65. A non-transitory computer-readable medium storing computer-executable instructions, the computer-executable comprising at least one instruction for causing a computer or processor to perform a method according to any of clauses 1 to 29.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of radio frequency (RF) sensing performed by a base station (BS), the method comprising:
determining a slot configuration that defines at least a portion of one or more slots as being configured for RF sensing; and
sending the slot configuration to at least one other telecommunications device.

2. The method of claim 1, wherein determining the slot configuration comprises:
receiving first information that defines the slot configuration;
receiving second information that defines a plurality of slot configurations, wherein each of the plurality of slot configurations defines at least a portion of one or more slots for RF sensing, and determining one of the plurality of slot configurations as the slot configuration; or
a combination thereof.

3. The method of claim 2, wherein determining one of the plurality of slot configurations as the slot configuration comprises receiving information that is used to select one of the plurality of slot configurations as the slot configuration.

4. The method of claim 1, wherein sending the slot configuration to at least one other telecommunications device comprises sending the slot configuration to at least one of a user equipment (UE), a network entity, or another base station.

5. The method of claim 1, further comprising performing RF sensing according to the slot configuration.

6. The method of claim 5, wherein performing RF sensing according to the slot configuration comprises performing RF sensing on a first component carrier according to a first slot configuration and performing RF sensing on a second component carrier according to a second slot configuration.

7. The method of claim 5, wherein performing RF sensing according to the slot configuration comprises performing RF sensing on a first component carrier and performing communication on a second component carrier.

8. The method of claim 5, wherein the one or more slots are divided into a plurality of mini-slots, and wherein all mini-slots are used for RF sensing, or wherein a subset of mini-slots are used for RF sensing while the remaining mini-slots are used for communication, according to the slot configuration.

9. The method of claim 5, wherein performing RF sensing according to the slot configuration comprises performing RF sensing using a first waveform comprising orthogonal frequency division multiplexing (OFDM) symbols, using a second waveform that does not comprise OFDM symbols, or a combination thereof.

10. The method of claim 5, wherein performing RF sensing according to the slot configuration comprises performing RF sensing for a duration that is a function of a subcarrier spacing configuration, that is statically configured, or that is dynamically configured.

11. The method of claim 5, wherein performing RF sensing according to the slot configuration comprises performing RF sensing according to a period, a repetition count, or a combination thereof.

12. The method of claim 1, further comprising sending, to at least one UE, an indication that the BS will transmit downlink transmissions that occur during the at least a portion of the one or more slots configured for RF sensing.

13. The method of claim 1, further comprising transmitting downlink transmissions that occur during the at least a portion of the one or more slots configured for RF sensing.

14. The method of claim 13, wherein transmitting downlink transmissions that occur during the at least a portion of the one or more slots configured for RF sensing comprises transmitting a synchronous signal block (SSB), a system information block (SIB), a paging signal, a physical downlink control channel (PDCCH), or a physical downlink shared channel (PDSCH).

15. The method of claim 1, further comprising sending, to at least one UE, an indication that the BS will measure uplink transmissions that occur during the at least a portion of the one or more slots configured for RF sensing.

16. The method of claim 1, further comprising measuring uplink transmissions that occur during the at least a portion of the one or more slots configured for RF sensing.

17. The method of claim 16, wherein measuring uplink transmissions that occur during the at least a portion of the one or more slots configured for RF sensing comprises measuring a physical random access channel (PRACH) or a physical uplink shared channel (PUSCH).

18. A method performed by a user equipment (UE), the method comprising:
receiving a slot configuration that defines at least a portion of one or more slots that is configured for RF sensing; and
operating according to the slot configuration.

19. The method of claim 18, wherein operating according to the slot configuration comprises:
determining that the at least a portion of the one or more slots for RF sensing occurs during a downlink (DL) transmission; and
measuring the DL transmission during the at least a portion of the one or more slots for RF sensing.

20. The method of claim 19, wherein measuring the DL transmission comprises measuring a system synchronization block (SSB), a system information block (SIB), a paging signal, a physical downlink control channel (PDCCH), or a physical downlink shared channel (PDSCH).

21. The method of claim 19, wherein operating according to the slot configuration comprises entering a low power mode or sleep mode during the at least a portion of the one or more slots configured for RF sensing and wherein measuring the DL transmission comprises waking from the low power mode or sleep mode to measure the DL transmission.

22. The method of claim 21, wherein operating according to the slot configuration comprises determining to wake from the low power mode or sleep mode to measure the DL transmission based on an indication, received by or provisioned to the UE, that a base station will transmit downlink transmissions that occur during the at least a portion of the one or more slots configured for RF sensing.

23. The method of claim 18, further comprising:
determining that the at least a portion of the one or more slots for RF sensing occurs during an uplink (UL) transmission; and
performing the UL transmission during the at least a portion of the one or more slots for RF sensing.

24. The method of claim 23, wherein performing the UL transmission comprises transmitting a physical random access channel (PRACH) or a physical uplink shared channel (PUSCH).

25. The method of claim 23, wherein operating according to the slot configuration comprises entering a low power mode or sleep mode during the at least a portion of the one or more slots configured for RF sensing and wherein performing the UL transmission comprises waking from the low power mode or sleep mode to perform the UL transmission.

26. The method of claim 25, wherein operating according to the slot configuration comprises determining to wake from the low power mode or sleep mode to perform the UL transmission based on an indication, received by or provisioned to the UE, that a base station will process uplink transmissions that occur during the at least a portion of the one or more slots configured for RF sensing.

27. A base station (BS), comprising:
a memory:
at least one transceiver; and
at least one processor communicatively coupled to the memory and the at least one transceiver, the at least one processor configured to:
determine a slot configuration that defines at least a portion of one or more slots as being configured for RF sensing; and
send, via the at least one transceiver, the slot configuration to at least one other telecommunications device.

28. The BS of claim 27, wherein, to determine the slot configuration, the at least one processor is configured to:
receive, via the at least one transceiver, first information that defines the slot configuration;
receive, via the at least one transceiver, second information that defines a plurality of slot configurations, wherein each of the plurality of slot configurations defines at least a portion of one or more slots for RF sensing, and determine one of the plurality of slot configurations as the slot configuration; or
a combination thereof.

29. The BS of claim 28, wherein, to determine one of the plurality of slot configurations as the slot configuration, the at least one processor is configured to receive information that is used to select one of the plurality of slot configurations as the slot configuration.

30. The BS of claim 27, wherein, to send the slot configuration to at least one other telecommunications device, the at least one processor is configured to send the slot configuration to at least one of a user equipment (UE), a network entity, or another base station.

31. The BS of claim 27, wherein the at least one processor is further configured to perform RF sensing according to the slot configuration.

32. The BS of claim 31, wherein, to perform RF sensing according to the slot configuration, the at least one processor is configured to perform RF sensing on a first component carrier according to a first slot configuration and perform RF sensing on a second component carrier according to a second slot configuration.

33. The BS of claim 31, wherein, to perform RF sensing according to the slot configuration, the at least one processor is configured to perform RF sensing on a first component carrier and perform communication on a second component carrier.

34. The BS of claim 31, wherein the one or more slots are divided into a plurality of mini-slots, and wherein all mini-slots are used for RF sensing, or wherein a subset of mini-slots are used for RF sensing while the remaining mini-slots are used for communication, according to the slot configuration.

35. The BS of claim 31, wherein, to perform RF sensing according to the slot configuration, the at least one processor is configured to perform RF sensing using a first waveform comprising orthogonal frequency division multiplexing (OFDM) symbols, using a second waveform that does not comprise OFDM symbols, or a combination thereof.

36. The BS of claim 31, wherein, to perform RF sensing according to the slot configuration, the at least one processor is configured to perform RF sensing for a duration that is a function of a subcarrier spacing configuration, that is statically configured, or that is dynamically configured.

37. The BS of claim 31, wherein, to perform RF sensing according to the slot configuration, the at least one processor is configured to perform RF sensing according to a period, a repetition count, or a combination thereof.

38. The BS of claim 27, wherein the at least one processor is further configured to send, via the at least one transceiver, to at least one UE, an indication that the BS will transmit downlink transmissions that occur during the at least a portion of the one or more slots configured for RF sensing.

39. The BS of claim 27, wherein the at least one processor is further configured to transmit, via the at least one transceiver, downlink transmissions that occur during the at least a portion of the one or more slots configured for RF sensing.

40. The BS of claim 39, wherein, to transmit downlink transmissions that occur during the at least a portion of the one or more slots configured for RF sensing, the at least one processor is configured to transmit a synchronous signal block (SSB), a system information block (SIB), a paging signal, a physical downlink control channel (PDCCH), or a physical downlink shared channel (PDSCH).

41. The BS of claim 27, wherein the at least one processor is further configured to send, via the at least one transceiver, to at least one UE, an indication that the BS will measure uplink transmissions that occur during the at least a portion of the one or more slots configured for RF sensing.

42. The BS of claim 27, wherein the at least one processor is further configured to measure uplink transmissions that occur during the at least a portion of the one or more slots configured for RF sensing.

43. The BS of claim 42, wherein, to measure uplink transmissions that occur during the at least a portion of the one or more slots configured for RF sensing, the at least one processor is configured to measure a physical random access channel (PRACH) or a physical uplink shared channel (PUSCH).

44. A user equipment (UE), comprising:
a memory:
at least one transceiver; and
at least one processor communicatively coupled to the memory and the at least one transceiver, the at least one processor configured to:
receive, via the at least one transceiver, a slot configuration that defines at least a portion of one or more slots that is configured for RF sensing; and
operate according to the slot configuration.

45. The UE of claim 44, wherein, to operate according to the slot configuration, the at least one processor is configured to:
determine that the at least a portion of the one or more slots for RF sensing occurs during a downlink (DL) transmission; and
measure the DL transmission during the at least a portion of the one or more slots for RF sensing.

46. The UE of claim 45, wherein, to measure the DL transmission, the at least one processor is configured to measure a system synchronization block (SSB), a system information block (SIB), a paging signal, a physical downlink control channel (PDCCH), or a physical downlink shared channel (PDSCH).

47. The UE of claim 45, wherein operating according to the slot configuration comprises entering a low power mode or sleep mode during the at least a portion of the one or more slots configured for RF sensing and wherein, to measure the DL transmission, the at least one processor is configured to wake from the low power mode or sleep mode to measure the DL transmission.

48. The UE of claim 47, wherein, to operate according to the slot configuration, the at least one processor is configured to determine to wake from the low power mode or sleep mode to measure the DL transmission based on an indication, received by or provisioned to the UE, that a base station will transmit downlink transmissions that occur during the at least a portion of the one or more slots configured for RF sensing.

49. The UE of claim 44, wherein the at least one processor is further configured to:
determine that the at least a portion of the one or more slots for RF sensing occurs during an uplink (UL) transmission; and
perform the UL transmission during the at least a portion of the one or more slots for RF sensing.

50. The UE of claim 49, wherein, to perform the UL transmission, the at least one processor is configured to transmit a physical random access channel (PRACH) or a physical uplink shared channel (PUSCH).

51. The UE of claim 49, wherein operating according to the slot configuration comprises entering a low power mode or sleep mode during the at least a portion of the one or more slots configured for RF sensing and wherein, to perform the UL transmission, the at least one processor is configured to wake from the low power mode or sleep mode to perform the UL transmission.

52. The UE of claim 51, wherein, to operate according to the slot configuration, the at least one processor is configured to determine to wake from the low power mode or sleep mode to perform the UL transmission based on an indication, received by or provisioned to the UE, that a base station will process uplink transmissions that occur during the at least a portion of the one or more slots configured for RF sensing.
